(19) United States
(12) Patent Application Publication
(10) Pub. No.: US 2012/0075442 A1
(43) Pub. Date: Mar. 29, 2012

(54) HANDHELD PORTABLE DEVICE FOR VERIFICATION OF TRAVEL AND PERSONAL DOCUMENTS, READING OF BIOMETRIC DATA AND IDENTIFICATION OF PERSONS HOLDING THESE DOCUMENTS

(76) Inventor: Sasa Vujic, Novi Beograd (RS)

(21) Appl. No.: 13/322,915

(22) PCT Filed: May 27, 2010
(86) PCT No.: PCT/RS2010/000007

§ 371 Date: Nov. 28, 2011

(30) Foreign Application Priority Data
May 29, 2009 (RS) P-2-009-0253

(51) Int. Cl. H04N 7/18; G06K 7/10

(52) U.S. Cl. 348/61; 235/472.01; 235/462.01; 348/E07.085

(57) ABSTRACT

A handheld device for reading biometric data and for the verification of travel and personal documents and the identification of persons holding these documents, comprising a full page document scanner with white, infrared and ultraviolet illumination, based on imaging sensors matrix, and contactless card reader with antenna covering the same area, thus enabling simultaneous optical and electronic document reading, the device further comprises a touch sensitive optical display, a fingerprint scanner, a contact card reader and a plurality of wired and wireless communication ports for the communication with a host computer.

### TECHNICAL FIELD

Handheld portable device for reading biometric data and verification of travel and personal documents and identification of persons holding these documents, according to this invention, belongs to the field of applications of information technology in control devices for testing the genuineness of travel and personal identification documents, such as passports, visas, identity cards, which utilize waves or particles of visible light, infrared (IR) and ultraviolet (UV) radiation, as well as devices for sensing record carriers by electromagnetic radiation, e.g. optical scanning of reflected light using light without wavelength selection, and devices for recognizing marks in the form of printed or written characters or recognizing patterns (e.g. fingerprints) using image processing i.e. processing of an image information without establishing its identity or to arrangements using optical reference masks, and belong as well to the devices for person identification and individual registration on entry or exit.

### BACKGROUND ART

Handheld portable device for checking passports and personal documents, reading of biometric data and identification of holders of these documents, according to this invention, solves the problem of the realization of a device intended for checking passports and personal documents, such as passports, visas or ID cards, including documents with embedded electronic chip (contact or contactless). These documents have been created according to latest international recommendations and standards for machine readable documents (e.g. ICAO 9303 recommendations of International Civil Aviation Organization and International Standard ISO 7501) and contains demographic and biometric data and safety features that can be machine readable, wherein checking involves scanning of the full page of a passport in different spectrum parts (illumination by white, infrared (IR) and ultraviolet (UV) light) as well as reading of actual electronic documents with a chip, either with contact (electronic identity card) or contactless interface (electronic passport). The device solves the problem of reading the machine readable zone of a document, text, data, 1D and 2D barcode and a digital watermark. The next problem to be solved by subject invention is the realization of a device, which in addition to checking authenticity of a document itself can do the automatic verification of a person presenting the document by comparing a fingerprint of a person with a fingerprint read from the document, which will be also able to compare a facial image of a person with a facial image read from the document, as well as to compare an eye iris of a person with an eye iris read from the document during so-called 1:1 verification, or the identity verification. The aim of this invention was also to find the solution for so-called 1:N verification, i.e. the problem of face identification, which is done when a person is without any document, when captured biometric data (a fingerprint, a facial and/or an eye iris images) are sent to a database, which is connected with the device using wire or wireless connection, wherein database search will be conducted. A further technical problem solved by this invention is the realization of the possibility to check watch list (which can be stored in a memory in the device itself).

Since it is necessary to provide fast and efficient document verification on border crossings, it has been proven that a documents control process carried out in a single location is unreasonably long, due to time required for collecting documents, their delivering to the check point with the control device and later passing the documents back to travelers, or the process when travelers with documents are passing by the control device where officials verify travelers documents, which also slows down travelers transit on border crossings, and thus need was established to solve the problem of achieving a simple device, which will be fully integrated, with ruggedized construction, compact by size, convenient to be carried in the hand and used in the field, e.g. on trains, buses etc.

The need to realize a multi-functional device for document reading that immediately after placing documents onto the device, will be able to simultaneously in very short time, read a number of different elements that are machine-readable according to the latest international recommendations and standards for documents (e.g. made in accordance with the ICAO 9303 recommendations of International Civil Aviation Organization and International Standard ISO 7501), which contain demographic and biometric data and safety features that can be read by a machine, to check the read data, compare with each other and show test results to authorized official who performs check, and also record and store each check result into an archive in order to perform additional check or search, has led to appearance of many different devices which may check and verify documents.

Existing handheld portable devices of known manufacturers, such as companies Datastrip Products Co. (USA), Bundesdrukerei GmbH (Germany), SAGEM (France) and others, have a number of significant disadvantages reflected in that: they do not perform full page document scanning, but only scanning of machine readable zone (MRZ); they also have to use separate modules in order to scan barcodes; furthermore, they can not extract a facial image from scanned images; in addition to that, they do not check a digital watermark from a facial image; and finally, they use only infrared (IR) light and thus there is no possibility for automatic verification of ultraviolet (UV) protective elements or variable optical elements (hologram or similar records), etc. The greatest shortcoming of solutions existing in the market is reflected in the fact that they contain either a mechanism which slowly run an open electronic passport through a linear scanner, and then place it in a particular position for reading contactless chip, or the open electronic passport is manually run over the machine readable zone (MRZ) reader, then is closed and placed in a position for contactless chip reading, and, if the document contains a barcode, an additional operation is required in order to perform barcode reading. In these solutions, an additional disadvantage is that bigger thickness of a document may create problems during passing through a device. There should be noted, that solutions with a mechanism running a passport through the device, have additional deficiency reflected in the existence of moving parts, which are subject to a malfunction or non-uniform operation, etc., and the greatest drawback of all solutions with the document trailing through reading devices is the existence of a possibility of document damage, i.e. problems occurring with thin flexible easy bendable pages of a document, which may be crumbled or even torn up, or a document may be jammed in the gap through which it is run. All of the above mentioned disadvantages cause an additional problem consisting in the fact that both hands of an operator are used during the reading of a machine-readable zone and a chip (up to 20 s).

In known solutions using optical line scanners, usually the later is assembled at the top of a device in order to perform reading, thus being exposed to the exploitation conditions, and as already mentioned, the long-term work increases failure possibilities of moving parts (due to their complex mechanical structures).

Another well-known shortcomings of known handheld devices consist in the fact that during the document trailing through scanner both hands of an official are used, and when after a few seconds, trailing of the document through the handheld device is completed, the operator perform an additional operation if the document contains a barcode, placing the document in front of a barcode reader. Further disadvantage of known solutions is also an additional operation required for reading contactless chip in the document. The existing handheld devices have small antennas for contactless chip reading, which in case of “shielded” e-passports (when document covers additionally contain conductive threads, so when the passport is closed, the passport covers additionally “shield” the chip) preventing its reading, so that an operator, again with both arms, must open a document, move it over the antenna, looking for the contactless chip position inside the document, and after finding it, the operator must be careful in order to read it properly, wherein he has to be very careful and concentrated on the accuracy of the performed reading. Beside all aforesaid, it is necessary to emphasize that known devices work with documents of limited thickness.

Solving problems and deficiencies of known solutions, e.g. realization of fully integrated portable handheld device with ruggedized construction, compact size, ergonomic features, suitable to be carried in the hand and used in the field, which in one position performs simultaneous optical scanning and electronic (wireless) reading of a document, whereas scanning begins by placing the document itself on the scanning/reading surface on the bottom of the device and along which will be provided an elastic holder of the document (so that official, after placing the document, has a free hand), where the full page optical scanning will be performed for documents with various sizes (up to size ID-3), as well as documents with different thicknesses, wherein aforesaid has resulted in the construction of the handheld portable device for reading biometric data and verification of travel and identity documents and identification of persons holding these documents, according to this invention.

### DISCLOSURE OF THE INVENTION

Handheld portable device for reading biometric data and verification of travel and personal documents and identification of persons holding these documents has solved the aforementioned technical problems and has eliminated stated disadvantages of known solutions, and is realized as fully integrated portable device for use in the field suitable for carrying in the hand, which has its own battery power supply (where the battery is charged by an appropriate adapter) whereas the base is provided, which, apart from battery charging port, has USB Client, USB Host, Ethernet and RS-232 ports for connection and communication between the device and PC. The handheld portable device for reading biometric data and verification of travel and identity documents and identification of persons holding these documents, according to this invention, has integrated computer and a large color display with touch screen, whilst the document (e.g. an electronic passport with a contactless chip) is placed on a large surface for optical scanning at the bottom of the device, so that the document is simultaneously optically scanned and data are read from the contactless chip. An optical scanner within the device is utilizing white, infrared (IR) and ultraviolet (UV) light, and the device also includes contact and contactless electronic card readers (smart cards), SAM module readers (like small SIM cards in mobile phones) and a fingerprint reader. The optional embodiment includes a camera to capture a facial image of a person and LED light (like flash), an eye iris scanning module with illumination, wireless communication modules (GSM/GPRS/EDGE/3G/CDMA, TETRA, Wi-Fi, WiMax, Bluetooth) and a GPS module, which provides information about the place (location) at which data have been taken in order to identify persons presenting the document. Besides stated wireless connections, the device may have many standard wired ports, such as: USB Client, USB Host, Ethernet and RS-232.

Simplicity in handling of the handheld portable device according to this invention is reflected in the possibility of simultaneous optical scanning of full passport pages from a little distance and reading chip content from a large area, thus achieving small device thickness. Machine readable zone of a document, text with data, 1D and 2D barcodes and digital watermark are read. Besides checking the authenticity of a document itself, it is possible to perform automatic verification of a person presenting the document by comparing a fingerprint of that person with a fingerprint read from the document, comparing a facial image of a person with a facial image read from the document, comparing an eye iris of a person with an eye iris read from the document (1:1 verification, or identity verification), as well as 1:N verification, i.e. an identification of a person performed in cases when a person does not have any document, when obtained biometric data (a fingerprint, a facial and an eye iris images) are sent to a database, connected with the device using wire or wireless means, wherein the database search is performed. There is also a possibility of checking watch list of wanted individuals where these data may be stored on the device itself.

### BRIEF DESCRIPTION OF DRAWINGS

Handheld portable device for reading biometric data and verification of travel and personal documents and identification of persons holding these documents, according to this invention, is shown in the accompanying drawings in which reference numbers indicate identical elements of the device and where:

FIG. 1 shows the appearance of a handheld portable device according to this invention on a battery charging stand with different connectors for the communication with a computer.

FIG. 2 shows the handheld portable device in the axonometric view with visible front, right and bottom sides of the device.

FIG. 3 shows the handheld portable device in the axonometric view with visible top, right and back sides of the device with a passport in data reading position.

FIG. 4 shows the handheld portable device in the axonometric view with visible top, right and back sides of the device without a passport.

FIG. 5 shows the internal axonometric view of the device with visible front, right and bottom sides without housing and without the optical scanner.

FIG. 6 shows the internal axonometric view of the device with visible top, right and back sides without housing.

FIG. 7 shows the internal axonometric view to the device with visible back, right and bottom sides without housing.

FIG. 8 shows the axonometric view of the optical scanner of the device with a passport leaning on a transparent surface in the reading position.

FIG. 9 shows a right side projection of the optical scanner with a passport leaning on a transparent surface in the reading position.

FIG. 10 shows the schematic layout of ID-3 format passports according to ICAO 9303 recommendations with a view to a data page and a partial view to the page with visa.

FIG. 11 shows the layout of data and readable zone on a standardized passport data page according to ICAO 9303 recommendations.

FIG. 12 shows the layout of data and readable zone on a standardized machine-readable visa according to ICAO 9303 recommendations.

FIG. 13 shows the layout of a standardized biometric ID cards in ID-1 size with layout of data and machine readable zone.

FIG. 14 shows block diagram of the handheld portable device.

FIG. 15 shows block diagram of the optical scanner of the handheld portable device.

FIG. 16 shows the application schematic of sensors and optics matrix.

FIG. 17 shows the applied illumination schematic.

FIG. 18 shows the optical scanning algorithm of the device.

FIG. 19 shows the usage and operation algorithm of the handheld portable device according to this invention.

### BEST MODE FOR CARRYING OUT OF THE INVENTION

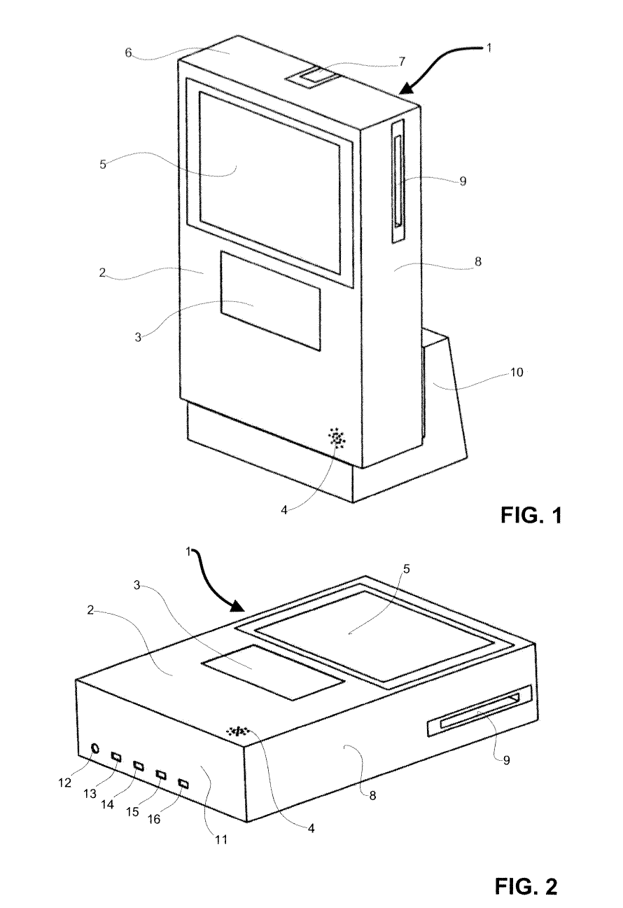

FIG. 1 shows the appearance of handheld portable device for reading biometric data and verification of travel and personal documents and identification of persons holding these documents, according to this invention, on a battery charging stand having various ports for the communication with a computer. A command panel 3 with functional keys (not shown), a loudspeaker 4 and a touch sensitive optical display 5 are integrated on the front side 2 of the housing 1 of the device. A fingerprint scanner 7 is placed on the top side 6 of the housing 1, while a rectangular slot for a contact card reader 9 is visible on the right lateral side 8. In the rest, a handheld portable device for reading biometric data and verification of travel and personal documents and identification of persons holding these documents is positioned on a stand 10 with interfaces enabling connections between ports on the bottom side 11 of the device with appropriate connectors of the stand 10 (for battery charging, communication with a host computer (USB and Ethernet ports, etc.)).

In FIG. 2 is shown the handheld portable device in the axonometric view with visible front 2, right 8 and bottom 11 sides of the device. A command panel 3 with functional keys (not shown), a loudspeaker 4 and touch sensitive optical display 5 are integrated at the front side 2, while a rectangular slot for the control card reader 9 is visible on the right side 8. There is a series of ports (port 12 for battery charging, USB Host connector 13, Ethernet port 14, USB Client port 15 and RS-232 port 16) on the bottom side 11 of the device, used for the communication of the device with a host computer.

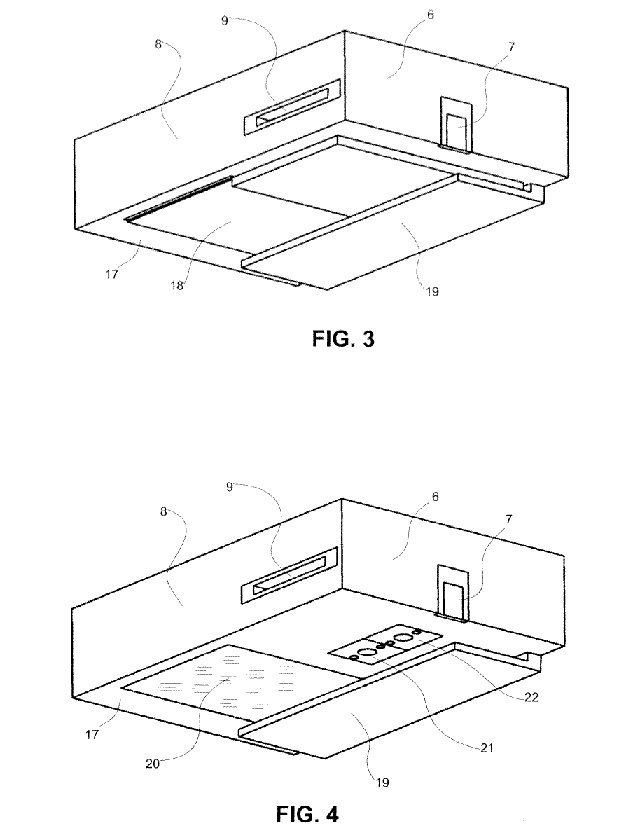

FIG. 3 shows the handheld portable device in the axonometric view with visible top 6, right 8 and back 17 sides of the device, with open passport 18 placed with data page on a transparent plate of the scanner (in the position for reading data) wherein the passport 18 is placed and fixed in the reading position by a flexible passport holder 19.

In FIG. 4 is shown a handheld portable device in the axonometric view with visible top 6, right 8 and back 17 sides of the device, without a passport, disclosing a transparent plate 20 (which may be of glass, solid plastic or other transparent material, and on which passports data page is placed) of a scanner on the bottom half of the back side 17 of the device, while on the upper half of the back side 17 is placed a camera 21 with an illumination for taking images of a person which identification and verification is performed, as well as a module 22 for scanning the eye iris of the same person.

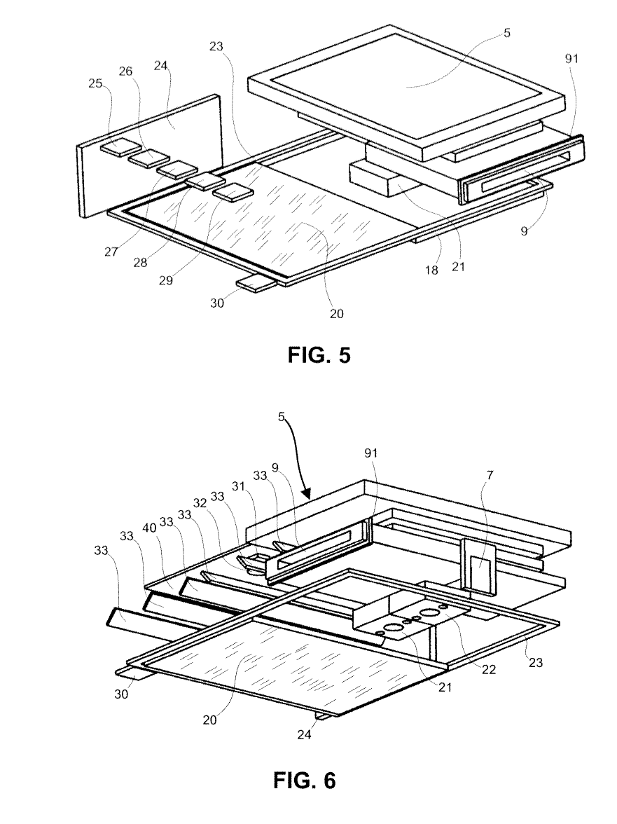

FIG. 5 shows the internal axonometric view of front, right and bottom sides of the device without the housing and without the optical scanner, where we see the positions of some elements stored inside handheld portable device for reading biometric data and verification of travel and personal documents and identification of persons holding these documents, according to this invention. The contactless cards reader 91 is envisioned near the contact cards reader 9. FIG. 5 also shows: a large antenna 23, which electromagnetic field covers the whole open passport 18 (both pages), then the battery 24, readers 25 and 26 of SAM chips (SAM1 and SAM2) inside which are stored cryptographic keys and other cryptographic elements of state-of-the-art digital protection systems, as well as series of modules 27, 28 and 29 for the wireless communication between the device and a computer, like a GPS module 30.

In FIG. 6 is shown the internal axonometric view of the device with visible top side with a fingerprint scanner 7, right and back sides without the housing, where we can see that scanner elements, such as sensors 31 with lenses 32 (shown only one) are arranged in a matrix on the supporting plate 40, as well as illumination carriers 33, on which white, infrared and UV LEDs are arranged.

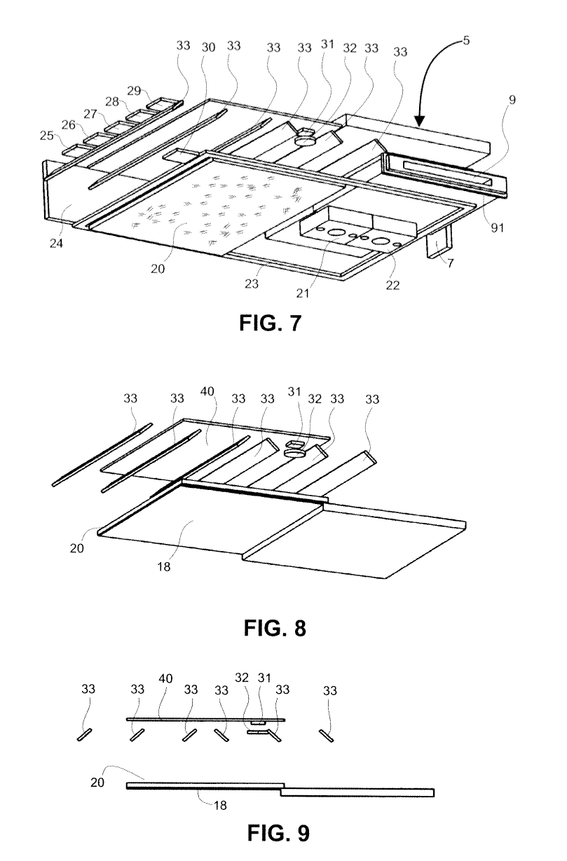

FIG. 7 shows the internal axonometric view of the device with visible back, right and bottom sides without the housing, where we observe the supporting plate 40 with scanner elements: sensors 31 with lenses 32 (only one shown) arranged in a matrix, as well as illumination carriers 33 with LEDs.

In FIG. 8 is shown the axonometric view to the optical scanner of the device, where a passport 18 is also shown leaning on the transparent surface 20 in the reading position, the position of only one unit is shown, which includes an optical image sensor 31 with lenses 32 in order to provide a clearer drawing, as these units are arranged in a matrix, so that each sensor scans only a part of the area, but with overlapping edge margins of adjacent sensors, resulting in a “total picture” made up of individual images of individual sensors, wherein the overlapping is unnoticeable.

FIG. 9 shows a side projection of the optical scanner with passport leaning on a transparent surface in the reading position, where is shown the mutual spatial arrangement of elements for illumination of an object to be scanned (the passport pages with data and images) and sensing elements consisting of sensors with optics, whereas only one unit is shown in order to simplify the drawing.

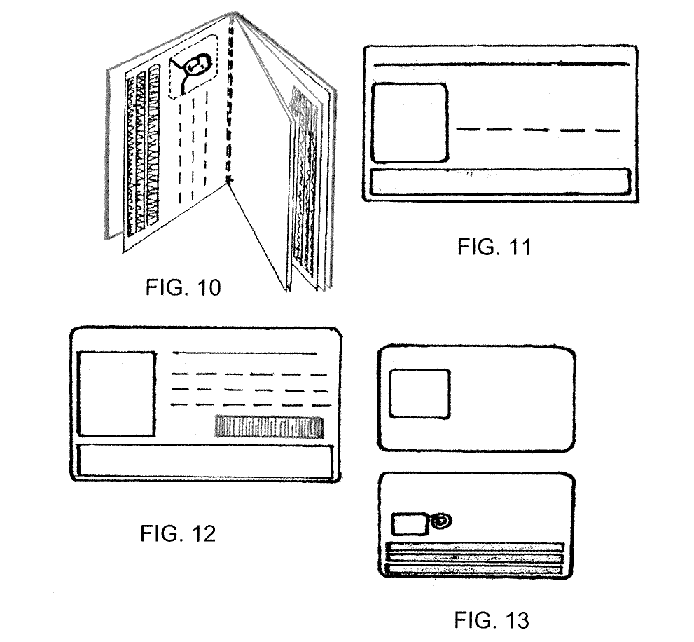

FIG. 10 shows the schematic layout of semi-open ID-3 format passport according to ICAO 9303 recommendations with a view to a data page and a partial view to a page with visa. On the data page 4 there is an area with the name of a country or an organization issuing the passport, zone with registered information on documents/passports type over an image of a passport holder, while right from the image is a zone for demographic information about the passport holder: surname, given name, birth data (place, date, etc.), personal identification number, residence address, issuance date and validity term, and others. Below the zone for demographic information is located zone for an optional barcode. At the bottom of identification data page on the document holder, throughout the whole height of the passport page there is a machine readable zone (MRZ) written with optical readable characters (OCR). There should be noted, that there exist passports with front and back covers containing conductive threads due to which passport is in its closed state “shielded”, i.e. the unauthorized reading of a contactless chip with biometric data is prevented without opening the passport.

FIG. 11 shows the layout data and the readable zone on standardized ID-3 format passport data page, according to ICAO 9303 recommendations, where the upper part comprises a zone with name of a state or an organization that issued the document, below which is located zone with registered information about document/passport type above the passport holders image in the left third of the middle zone, whilst on the two-thirds of the middle zone are spread demographic data about the passport holder (surname, given name, birth data (place, date, etc.), personal identification number, address of residence, date of issue and validity period, etc.), while under this zone is located the zone provided for an optional barcode. At the bottom of the page with document holder identification data, throughout the whole height of the passport page is located a machine readable zone (MRZ) written with optical readable characters (OCR) that can be read by scanner.

FIG. 12 shows the layout data and the zone for reading of a standardized machine-readable visa according to ICAO 9303 recommendations, which has similarly arranged data, and may include a contactless chip with data that can be read only through an antenna.

FIG. 13 shows the appearance of standardized biometric ID cards in ID-1 size with layout of data and machine readable zone, with a chip that has a contact interface and below which is located machine readable zone with three strips (3 line MRZ). In accordance with the types of documents, which are defined in ICAO 9303 recommendations, or in ISO 7501 standard, handheld portable device according to this invention can read passports (ID-3 size), visas form A (which can fit into ID-3 documents), visas form B (of ID-2 size), TD1 cards (ID-1 size), TD2 cards/labels/stickers (ID-2 size), as well as national ID cards and driving licenses.

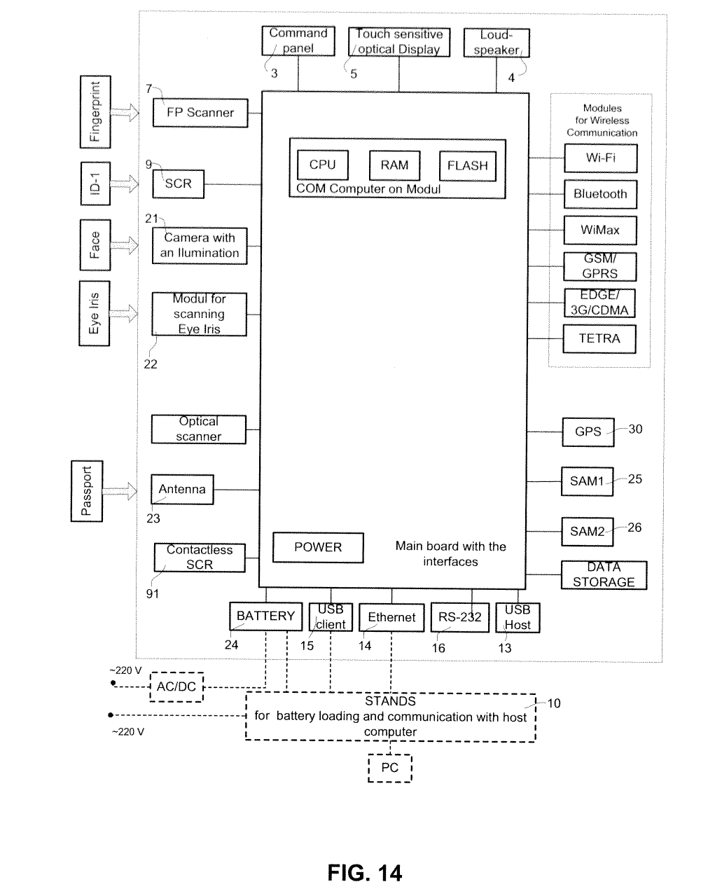

FIG. 14 shows a block diagram of the handheld portable device for reading biometric data and verification of travel and personal documents and identification of persons holding these documents, according to this invention, in which we see the basic construction idea and electronic components contained in this portable handheld device, which are denoted by the same reference numbers as identical assemblies of the device in the drawings, which allow that portable handheld device, according to this invention, performs checking and verification of travel and identity documents (passports, visas, ID cards, documents with embedded contactless or contact chip), reads biometric data, such as a fingerprint, a facial and an eye iris images of a document holder, and on the basis of these so-collected data identify document holders, but also performs recognition of persons without documents, by taking on-site data on fingerprints, taking photos of persons without documents and recording their eye iris and comparing that data with data taken from a database of individuals to whom travel documents or personal identification data have been issued, by sending taken data to a host computer and by downloading returned data from the host computer which appears on the optical display 5 of the handheld portable device, whereas the operator through touch sensitive optical display 5 and through functional keypad of the command-panel 3 communicates with the host computer over wired or wireless connection.

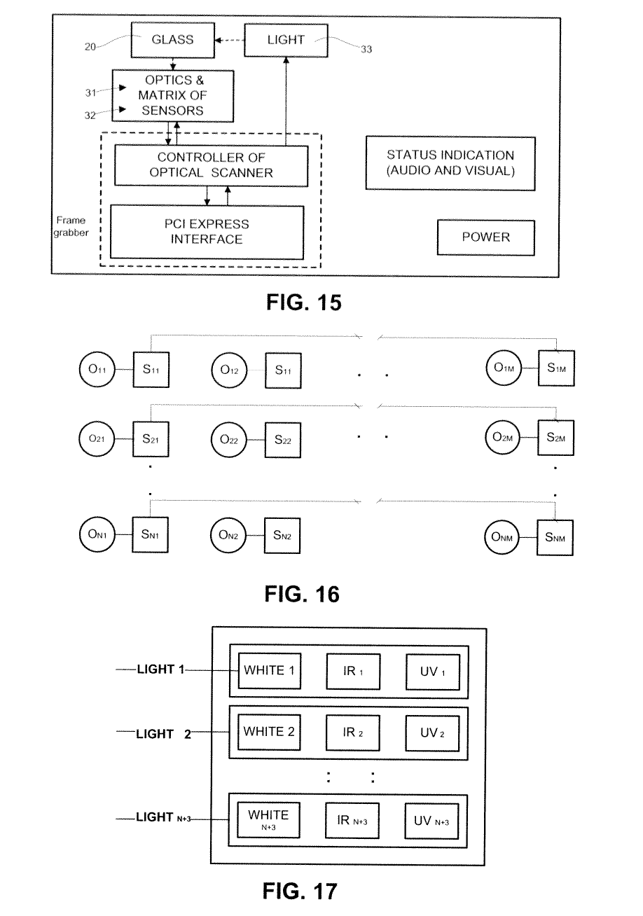

In FIG. 15 is shown a block diagram of an optical scanner of the handheld portable device, with the solution of an electronic optical scanner implemented in the handheld portable device that allows scanning of large areas at small distances, using different types of illumination, wherein besides the aforementioned elements of the transparent surface 20, the assembly of more sensors 31 (CMOS sensors or in general CCD sensors with additional A/D converters and components for signal synchronization) with the lenses 32, arranged in a matrix N×M (where N, M=1, 2, 3 . . . , i.e. in the realized device N=3 and M=4), and the illumination assembly 33 composed of N+3 rows of panels with LEDs (in the realized device N=3) that radiate white, IR and UV light and are placed so that they do not fall into the field of view of any of sensors 31 and that the reflected rays, resulted from the total reflection, do not fall into the field of view of the corresponding sensor, and to achieve as much as possible homogenous light (white, IR and UV). We note the electronic controllers assembly of optical scanner, which control illumination and, if necessary, turns on just these LEDs that are needed for the particular sensor and the selected light (white, IR, UV). Since each sensor 31 scans “its” part of an object (part of the whole documents page), but with an additional margin, so that adjacent sensors scan the part of the objects surface that is common to both sensors, which further allows matching of individual images in a large (integral) picture so that the joints are not perceived. Electronic assembly that accepts and transmits individual images of sensors 31, sets the parameters for the operation of sensors 31 and control illumination carriers 33, so-called frame grabber, consists of an optical scanner controller (I2C controller), which communicate with sensors 31, the registers that control illumination carriers 33, RAM memory for the temporary capture and storage of scanned images, a logic providing control and synchronization signals and interfaces, i.e. PCI Express controller, which accepts data and transmits them to the processing unit (in the realized solution to a miniature personal computer PC, i.e. to the computer with x86 architecture) so that outputs of each of individual sensors 31 are connected to a common 8-bit bus for data transfer (data bus) through which data on the image recorded by a single sensor 31 are disposed. The connection is also possible through 32-bit data bus accepting data sent out by four sensors 31 from one matrix row. The procedure of placing the document, scanning and ending of the scan is followed by (audio and visual) indication of the status and appropriate powering up of components and assemblies.

FIG. 16 shows the applied matrix of surface optical sensors S with object lens O for each sensor in the matrix of N×M (N, M=1, 2, 3, . . . ), which are arranged in the realized device in the 3×4 matrix, which is parallel with the transparent surface 20 (which may be glass, hard transparent plastics, etc.), so that each sensor 31 scans “its” part of the object (whole document page) of which an integral image is made.

In FIG. 17 is shown a block diagram of applied illumination consisting of equal plates with LEDs on each plate that radiate white light, IR light and UV light, whereby each row of sensors goes one pair of plates with LEDs. In an example of the embodiment, illumination consists of six equal carrier plates 33 with LEDs for white, IR and UV light, while these six plates are geometrically arranged in three pairs of plates (1-4, 2-5, 3-6), so that with each row of sensors goes by one pair of plates with LEDs. Each of the plates and LEDs on it provide intensive and as much as possible homogenous light (white, IR and UV), and are placed so they do not fall into a field of view of any sensors. Also, the reflected rays, which are due to total reflection, do not fall into a field of view of the corresponding sensor. Electronic controller for illumination control allows turning on just those LEDs that are needed for the particular sensor and for the selected light. When, for example, white image scanning is performed with one of four sensors from the first row, only white LEDs on the first and fourth (1-4) illumination plates are turned on. When white image scanning is performed with one of four sensors from the second row, only white LEDs on the second and fifth (2-5) illumination plates are turned on. When white image scanning is performed with one of four sensors from the third row, only white LEDs on the third and sixth (3-6) illumination plates are turned on. In such a way it is possible to perform successive scanning with all 12 sensors, without interference due to total reflection of LEDs.

The procedure for image scanning using another type of illumination (IR or UV) is the same, but only other LED lights are selected and turned on. It is possible to perform simultaneous scanning of all four sensors from the same row, repeating it three times for three rows of sensors. This solution is better since it allows faster scanning, but the control electronics is more complex.

It is possible to generalize the described scanner, by making N×M matrix. In this case, illumination will be realized as N pairs of illumination panels. However, after the analysis had been carried out, it has been shown that the solution with 3×4 sensors is optimal for providing smallest overall dimensions, in order to scan the surface of ID-3 size documents.

When the handheld portable device is made and assembled, its calibration is performed, i.e. the definition of parameters of images that will be used later for manipulating and fitting of single sensor images into an integral image of the desired quality, whilst the device calibration is done only once during the manufacturing of the device. Special scanned objects (printed on a flat surface) are used for the calibration purposes. Parameters are determined, stored and kept in a permanent storage of the device itself. These parameters are essential for obtaining high-quality integral image. In the course of using the device, when a document is optically scanned, saved parameters are used during processing which results in an integral image without visible irregularities. In the case of misalignment due to long-term operation, it is possible to repeat the calibration procedure.

Calibration process is performed in two steps. In the first step, an image of homogeneous gray area is taken with all 12 sensors, on the basis of which parameters for white balance are defined (for the picture colorization), as well as the parameters for correction of nonuniformity, caused by light nonuniformity due to illumination and due to characteristics of lenses bringing in additional nonuniformity. In the second step, a separate calibration image is taken with all 12 sensors, on the basis of which the parameters for the geometric correction and image matching. Algorithms for light nonuniformity correction, geometric correction and image matching are dedicated developed algorithms (as well as images and calibration procedures), which makes possible to obtain quality integral image as a result, as it was taken by a single camera or by a standard scanner. These algorithms are executed on the processor unit.

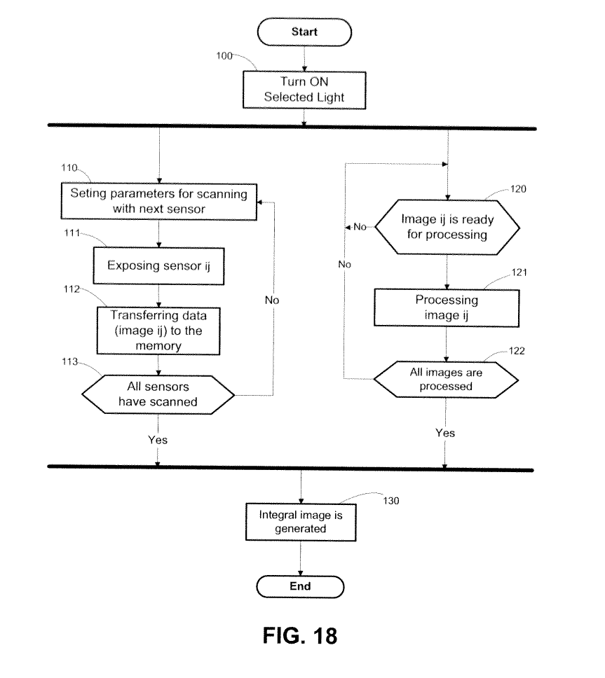

FIG. 18 shows the algorithm for performing optical scanning in the subject handheld portable device, in order to obtain an integral image based on individual images of sensors 31, which begins by placing a document on the transparent surface 20, when selected illumination is turned on in step 100. After image illumination is turned on in step 100, parameters for scanning with next sensor are set in step 110, the sensor is exposed in step 111, and resulting data (image) is transferred to the memory in step 112. The control electronics checks whether all sensors are scanned in step 113, and if not, set parameters for scanning with next sensor in step 110. The whole process is repeated until check 113 confirms that all sensors are scanned. Simultaneously with the aforesaid scanning, check of image readiness for processing is performed in step 120, and if ready, the processing of received image is performed in step 121. When all images are processed in step 122, the integral image is generated in step 130, thus ending scan process.

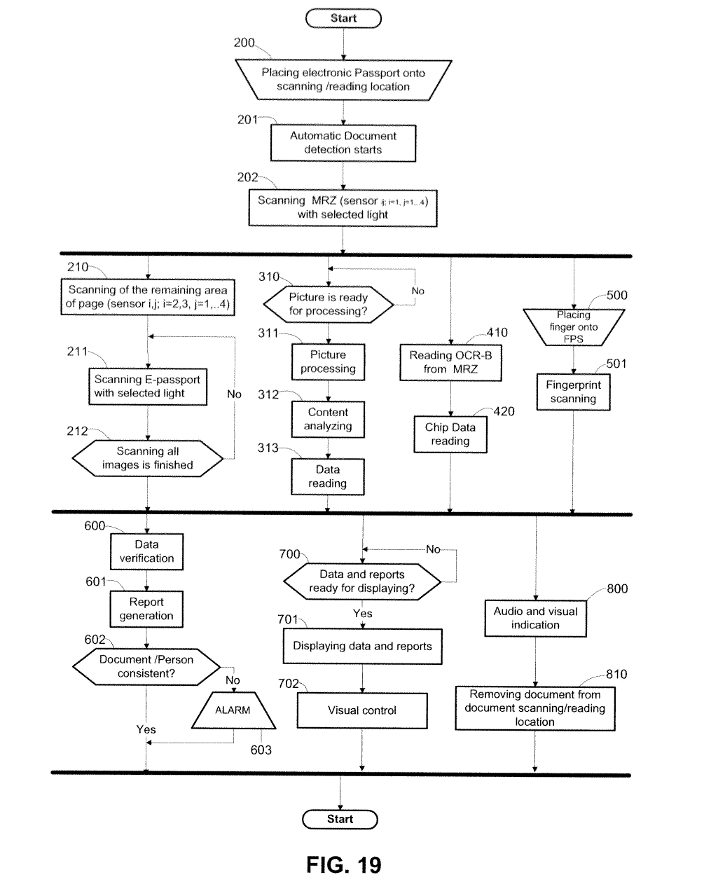

FIG. 19 shows the algorithm of using and operating the handheld portable device while checking travel and personal documents with contactless chip, as well as the verification of identity of document holders presenting such documents like passport, visa or ID card, while identification of persons without documents, taking of facial images or eye iris images of persons and reading of the contact chip, etc are not shown here. The presented algorithm shows a check which includes scanning of whole page of a passport by illuminating with white, IR and UV light, as well as reading of current electronic documents with chip, either with contact (e-ID) or a contactless interface (electronic passport), where reading of machine readable zone (MRZ) of the document, text data, 1D and 2D barcodes and digital watermark are performed. ID-1 format document will be normally read regardless of its orientation while placing it on the transparent plate 20 with page bearing code facing the scanner. In addition to checking the validity of the document, it is also possible to do the automatic verification of the document holder, by comparing the scanned fingerprint with the fingerprint read from the document, comparing a facial image of the document holder with a facial image read from the document, comparing an eye iris image of the document holder with an eye iris image read from the document (this is so-called 1:1 verification, or verification of individuals identity).

The process begins by placing electronic passport 18 in step 200 on the transparent surface 20 facing the open page with image and data of a document holder, when automatic document detection starts in step 201, after which scanning of machine-readable zone (MRZ) begins using the selected light in step 202. Scanning of the remaining area of a page of the document is performed in step 210, while scanning with selected light is performed in step 211. Scanning of the whole document page by remaining types of light is performed until scanning of all images is finished in step 212. Simultaneously with steps 210 to 212, the following steps: checking whether an image is ready for processing in step 310, and if ready, image processing in step 311, image content analysis in step 312 and data reading in step 313 are performed. Reading of optical characters from scanned documents MRZ is performed in step 410 (OCR-B characters located in MRZ) and reading of chip data is performed in step 420. After putting a finger of the document holder in step 500 onto the fingerprint scanner 7, handheld portable device will perform fingerprint scan in step 501.

In the further procedure, data verification is performed in step 600, report is generated in step 601, and wrong matching between data read from the document and data about the document holder in step 602 activates the alarm in step 603. Simultaneously with steps 600 to 603 are performed: data and report preparation for displaying in step 700, data and report displaying in step 701 on the optical display 5, and visual control in step 702 by authorized person, who performs validation of documents and/or person. Audio and visual indication in step 800 will show the status of document reading process and show that document reading process is finished, after which the document removal from document scanning/reading location is performed in step 810, when the handheld portable device will be ready to a new start and new verification of travel and identity documents, as well as check of the identity of a document holder, such as passport, visa or ID card (so called 1:1 verification, or identity verification). As already aforesaid, it is possible to perform 1:N verification i.e. identification of individuals, when a person does not have a document, and when biometric data (a fingerprint, a facial and an eye iris images) taken with this handheld portable device are sent to the database, connected with the handheld portable device by wire or wireless means, where database search will be performed. Also, it is possible to check watch lists of wanted persons which can be stored in the device itself.

### INDUSTRIAL APPLICABILITY

By inspection of the attached drawings of handheld portable device for reading biometric data and verification of travel and personal documents and identification of persons holding these documents according to the disclosed invention, it is possible to determine its advantages and opportunities, since the device according to this invention can read the documents (as defined in ICAO 9303 recommendation, or in ISO 7501 standard) like passports (ID-3 size), visas in format A (which can fit into ID-3 documents), visas in format B (size ID-2), TD1 cards (size ID-1), TD2 cards/labels/stickers (size ID-2), as well as national ID cards and driving licenses.

It is known that the position of a chip with an antenna is arbitrary within a document, and thus is noted that, for example, in a passport, it can be found either in the front or back cover, on the data page or between the pages in the middle of a passport. Neither its position nor orientation within the page is defined. Handheld portable device, according to this invention, enables reading of the chip content, regardless where the chip and the antenna are placed in the document and that in the primary and only position of the document on the device, in which position the document is set for reading and/or verification. This, among others, is possible due to a large antenna corresponding to the size of two ID-3 documents (size of an open passport). In another embodiment, this can be achieved by placing two antennas of smaller dimensions, wherein each one of them has one half of an open passport within its range.

It is also known that an image of a person in a document might be protected by a digital watermark that can be checked. Handheld portable device, according to this invention, enables extraction of a content which confirms the validity of a digital watermark from an image of a person, obtained by optical scanning of documents and appropriate processing.

In addition to the advantages previously mentioned in the specification of a handheld portable device, according to this invention, we see that at the same time, in one position, it performs an optical scanning and electronic (wireless) reading of a document, while flexible document holder allows that operator has a free hand after placing the document to scanning/reading position. The advantage is also that scanning/reading process automatically starts by placing the document on a transparent surface for scanning/reading, and since the position of the document during scanning/reading is at the back side of the device, an operator has free access to the touch sensitive optical display 5, located on the front side, in order to enter data or read the reports. Further advantages are reflected in the fact that optical scanning of the whole page of documents of various sizes (up to ID-3 size) and of different thickness is performed, while the optical scan of a document is performed with white, IC and UV light, while automatic extraction and reading of data from machine-readable zone (MRZ) of a document is performed, and automatic extraction and reading of data from 2D barcode is performed, as well as extraction and reading of data from a 1D barcode. The great advantage is the possibility to extract a facial image from the scanned document and check a digital watermark from the extracted facial image from the scanned document. Since the subject handheld portable device utilizes white, IC and UV light to illuminate the document during scanning, the advantage is also the possibility to extract protective elements visible in UV light and a comparison with the corresponding forms in the database of known documents, as well as the extraction of protective elements changing the appearance during changing the angle of the illumination. Reading data from the contact chip (the document is placed into a contact card reader CCR), fingerprint scanning, as well as the possibility of simultaneous fingerprint scanning and scanning/reading the document and comparing the scanned fingerprint with the fingerprint read from the chip (1:1) or comparison of scanned fingerprint with the fingerprint read from 2D barcode (1:1) are further advantages of this device, as well as taking a facial image of the document holder and comparison of extracted facial image from the scanned document with a facial image taken by photographing the document holder (1:1), or comparison of a facial image read from the chip with a facial image taken by photographing the document holder (1:1). Another additional advantage is taking (photographing) an eye iris image of the document holder and comparison of an eye iris image read from the chip with an eye iris image taken by photographing the document holder (1:1) which achieves more accurate recognition of a person carrying the document. Handheld portable device has also the possibility of locating the place where the recognition procedure is performed (so-called data geo-tagging) using the built-in GPS module that can provide information on a position and time which data are attached to data on checked document/person.

Handheld portable device according to this invention, can be connected to a database, by wire or wireless means (possible interfaces are listed in the drawings and in the description of this invention), and to compare documents/persons with the database of wanted documents/persons, whereas the database can be stored in a memory in the device itself or stored on a remote site.

To illustrate the possibilities and advantages of the subject device we state that it can perform storage of data on checked person/document into a memory in the device itself, or later to transfer stored data into a database (by wire or wireless means), and since the device is connected to the database placed in some computing center, the device may make and send queries to the database for the identification of persons (search 1:N) found without travel or other identity document (ID card, driving license, etc.) and can perform other verifications.

The advantage is also the possibility of transferring data from the device or to the device simultaneously with battery charging, and it is possible to replace the battery “alive”, i.e. during the device operation.

Although the handheld portable device for reading biometric data and verification of travel and personal documents and identification of persons holding these documents is described with the reference to a specific embodiment shown in the drawings, it is clear that the disclosed solution is used only to illustrate the subject invention and that some details of the construction, mutual arrangement of assemblies and embodiments of individual elements of the construction, as well as certain steps in the process may be changed in relation to those described and shown in the aforesaid specification and drawings, which does not depart from the concept of subject invention as defined in the following claims.

1-14. (canceled)

15. A handheld portable device for reading biometric data, verification of travel and personal documents, and identification of persons holding these documents, comprising a document scanner comprising:
a plurality of optical sensors with lenses; and
a plurality of illumination carriers,
wherein light from selected illumination carriers is reflected from the scanned document before reaching selected optical sensors with lenses.

16. The handheld portable device of claim 15, wherein said optical sensors with lenses are assembled in a rectangular matrix.

17. The handheld portable device of claim 15, wherein said optical sensors are selected from a group comprising:
CCD optical sensors; and
CMOS optical sensors.

18. The handheld portable device of claim 15, wherein said illumination carriers are assembled in rows.

19. The handheld portable device of claim 15, wherein said illumination carriers comprise light emitting diodes (LEDs).

20. The handheld portable device of claim 15, wherein said illumination carriers radiate white, infrared and ultraviolet light.

21. The handheld portable device of claim 15, wherein said illumination carriers are positioned outside of field of view of any of said optical sensors with lenses.

22. The handheld portable device of claim 15, wherein said selected illumination carriers are positioned within the field of view of said selected optical sensors with lenses using the reflected rays from the document.

23. The handheld portable device of claim 15, wherein said document scanner further comprises at least one device selected from a group of devices comprising: capturing device, for capturing images from said optical sensors;
memory for temporary storing the captured images;
the logic circuitry for setting the parameters of the operation of said optical sensors; the logic circuitry for controlling said illumination carriers;
the logic circuitry providing control signals for transmitting stored captured images;
and a common data bus for simultaneous reading of captured images of selected optical sensors.

24. A handheld portable device of claim 15, further comprising at least one device selected from a group of devices comprising: a contact card reader;
a contactless card reader;
a camera with illumination for taking photos of a person;
an eye iris scanning module;
a fingerprint scanner;
an antenna which electromagnetic field covering at least one document page;
readers for SAM1 and SAM2 chips with stored cryptographic keys;
a touch sensitive optical display;
a command panel with functional keys;
GPS module;
Wi-Fi module;
Bluetooth module;
WiMAX module;
GSM/GPRS module;
EDGE/3G/CDMA module;
TETRA module;
a plurality of communication ports for the communication with a host computer;
a battery;
a housing;
a loudspeaker; and
a flexible document holder.

25. A method of document scanning by handheld portable device for reading biometric data, verification of travel and identity documents and identification of persons holding these documents comprising the steps of:
a) setting the capturing parameters for the next optical sensor;
b) exposing the next optical sensor;
c) capturing and storing image into a memory;
d) performing steps a) to d) until all optical sensors are exposed; and
e) generating an integral image from all stored images into a memory.

26. Method of documents scanning of claim 5, further comprising the steps of:
a) turning on the selected type of the illumination;
b) scanning of the machine-readable zone of the document with first set of optical sensors;
c) scanning of the remaining area of a page of the document with remaining optical sensors; and
d) performing steps a) to d) until images corresponding to all types of the illumination are generated.

27. Method of documents scanning of claim 25, further comprising the steps of:
a) placing a document onto the transparent surface of a document scanner portion of said handheld portable device;
b) automatic detection of the presence of the document; and
c) document removal from the scanning position.

28. Method of documents scanning of claim 25, further comprising the steps of:
a) checking if captured images are ready for processing;
b) processing captured images that are ready for processing; and
c) analyzing content of processed captured images.

29. Method of documents scanning of claim 25, further comprising the steps of:
a) reading data from the document;
b) verification of data read from the document;
c) comparison between data read from the document and data obtained from a person; and
d) alarm generation in case of false comparison in step d).

30. Method of documents scanning of claim 25, further comprising the steps of:
a) audio and visual indication showing the status of document scanning;
b) data and report preparation for displaying on the display;
c) data and report displaying on the display; and
d) visual checking of data and reports on the display.

31. Method of documents scanning of claim 25, further comprising the step of:
reading of optical characters and a barcode from the machine-readable zone (MRZ) of scanned document (OCR-B characters located in MRZ).

32. Method of documents scanning of claim 25, further comprising the step of: reading of data stored in a chip.

33. Method of documents scanning of claim 25, further comprising the steps of:
a) placing a finger of a person on a fingerprint scanner;
b) fingerprint scanning;
c) sending data to a database connected to the device by wire or wireless means; and
d) database search.

34. Method of documents scanning of claim 25, further comprising the steps of:
a) taking a facial image of a person;
b) taking an eye iris image of a person;
c) sending data to a database connected to the device by wire or wireless means; and
d) database search.
